(19) United States
(12) Patent Application Publication
(10) Pub. No.: US 2012/0031763 A1
(43) Pub. Date: Feb. 9, 2012

(54) ELECTRODIALYZER

(76) Inventors: Tadahiro Ohmi, Miyagi (JP); Tetsuya Goto, Miyagi (JP); Tomotsugu Ohashi, Miyagi (JP); Keita Fushimi, Miyagi (JP); Takashi Imaoka, Tokyo (JP)

(21) Appl. No.: 13/265,411

(22) PCT Filed: Apr. 20, 2010
(86) PCT No.: PCT/JP2010/056970

§ 371 Date: Oct. 20, 2011

(30) Foreign Application Priority Data
Apr. 21, 2009 (JP) 2009-102560
May 14, 2009 (JP) 2009-117698

(51) Int. Cl. C02F 1/469; B01D 61/46; C02F 103/08

(52) U.S. Cl. 204/633; 204/630

(57) ABSTRACT

An object of this invention is to provide an electrodialyzer which is effective in saving electric power. According to this invention, there is provided an electrodialyzer which electrically dialyzes water to be processed while a voltage causing substantially no current to flow is applied between an anode and a cathode.

### TECHNICAL FIELD

This invention relates to an electrodialyzer and, in particular, relates to an electrodialyzer of a low power consumption type.

### BACKGROUND ART

As an example of using an electrodialyzer, a seawater desalination apparatus is known. For example, Patent Document 1 describes a seawater treatment apparatus comprising a reverse osmosis separation apparatus for desalinating seawater to obtain fresh water and an electrodialyzer for further concentrating concentrated water discharged from the reverse osmosis separation apparatus.

Patent Document 2 discloses an electrodialysis method with a plurality of pairs of electrodialysis chambers having a group of ion exchange membranes with selective ion permeability, which supplies conductivity waters with different electrolyte concentrations in series with respect to the plurality of pairs of electrodialysis chambers and energizes them to cause a large amount of current to flow in the low electrolyte concentration water, thereby improving the electrolyte removal ratio.

Further, Patent Document 3 describes using a multistage electrodialyzer for obtaining high concentration bittern.

However, all of Patent Documents 1 to 3 omit a detailed explanation of the electrodialyzer itself. Therefore, it is not possible to infer a problem in the electrodialyzer from Cited Documents 1 to 3.

Herein, referring to FIG. 1, a problem in an electrodialyzer will be clarified. As shown in FIG. 1, the electrodialyzer has a structure comprising an anode 101, a cathode 102, negative ion (anion) exchange membranes 103, and positive ion (cation) exchange membranes 104, wherein a plurality of pairs of the cation exchange membranes and the anion exchange membranes that are alternately disposed are sandwiched between the two (pair of) electrodes and water to be treated flows between the ion exchange membranes.

When a voltage is applied to the pair of electrodes, cations in the water move toward the cathode 102 side while anions in the water move toward the anode 101 side. In this event, the cations can pass through the cation exchange membrane, but cannot pass through the anion exchange membrane. On the other hand, the anions cannot pass through the cation exchange membrane, but can pass through the anion exchange membrane. As a result, desalination chambers 106 and concentration chambers 105 are formed. For example, when seawater is introduced as feed water to be treated, the water in the desalination chambers 106 is obtained as fresh water. In a normal electrodialyzer for seawater desalination, a plurality of pairs of ion exchange membranes are disposed between a pair of electrodes for making the electrodialyzer compact and inexpensive, and the electrodialyzer is operated at an interelectrode voltage of several 100V and at an electrode current density of several 10 mA/cm². For example, if the electrode area is 1 m² (10000 cm²) and the current density is 10 mA/cm², the total current becomes 100A and, if the interelectrode voltage is 100V, the required power becomes 10 kW and thus very large power is consumed.

Further, the power increase becomes a more serious problem in Patent Documents 2 and 3 in which the electrodialyzer has the multistage structure.

### PRIOR ART DOCUMENT

### Patent Document

Patent Document 1: JP-A-H9-276864
Patent Document 2: JP-A-2003-94063
Patent Document 3: JP-A-2005-287311

### SUMMARY OF THE INVENTION

### Problem to be Solved by the Invention

As described above, the conventional electrodialyzer has the problem that very large power is required.

Therefore, this invention aims to provide an electrodialyzer with less power consumption.

### Means for Solving the Problem

With respect to the above-mentioned problem, the present inventors have studied whether or not it is possible to reduce a voltage to be applied between electrodes, as a means for reducing the power consumption.

Specifically, first, the present inventors have paid attention to the fact that when a voltage is applied to the electrodes, the following phenomenon occurs between ions and water molecules in water and the electrodes. Specifically, when the voltage is applied to the electrodes, current does not flow between the electrodes immediately after the application of the voltage while the cations in the water start to move toward the cathode and the anions in the water start to move toward the anode (first phase). Further, when the voltage continues to be applied and exceeds a certain threshold voltage, electrons are transferred between the electrodes and the ions and water molecules in the water, i.e. the electrode reaction occurs, as a second phase so that the current starts to flow between the electrodes (second phase). This threshold voltage depends on the ion species and concentration in the water and the temperature thereof and further depends on an electrode material and so on.

Herein, the present inventors have found that, in order to move the ions, the conventional electrodialyzer is operated at a voltage where the electrode reaction proceeds in the above-mentioned second phase, and that this causes the power consumption to be large. Specifically, since the conventional electrodialyzer has the structure in which the plurality of pairs of ion exchange membranes are sandwiched between the pair of electrodes, the amount of ions to be moved by the pair of electrodes is large. Therefore, it is necessary to provide a large potential difference between the electrodes and, as a result, the interelectrode voltage exceeds an electrode reaction threshold voltage.

Accordingly, the present inventors have considered that if electrodialysis is carried out at an interelectrode voltage that does not exceed an electrode reaction threshold voltage, ions can be moved with almost no current flowing and thus a low power consumption type electrodialyzer is realized. In order for this, a high voltage cannot be applied, and therefore, it is necessary to construct a system that moves as small an amount of ions as possible with a pair of electrodes. As a consequence, the present inventors have found that, using as a basic unit a structure in which a pair of a cation exchange membrane and an anion exchange membrane are disposed between a pair of electrodes, electrodialysis can be carried out at an interelectrode voltage that does not exceed an electrode reaction threshold voltage.

Specifically, according to one aspect of this invention, there is obtained a low power consumption type electrodialyzer which has a structure in which, between opposed electrodes, a cation exchange membrane is provided on the anode side while an anion exchange membrane is provided on the cathode side, and which is adapted to move ions by supplying seawater between the electrodes and the ion exchange membranes and supplying seawater or fresh water between the cation exchange membrane and the anion exchange membrane and by applying a voltage, substantially not causing current to flow, between the electrodes.

On the other hand, the present inventors have made further studies on a means that reduces a voltage to be applied between electrodes as compared with conventional.

As a result, the present inventors have also found that, using as an electrode material a material with higher electron emission characteristics than that of a conventional electrode material, the electrode reaction can proceed at a lower voltage than conventional, i.e. the voltage to be applied between the electrodes can be reduced as compared with conventional.

According to another aspect of this invention, there is provided an electrodialyzer having a structure in which a plurality of pairs of anion exchange membranes and cation exchange membranes are disposed in parallel and are sandwiched on both sides thereof by an anode and a cathode, the electrodialyzer characterized in that Pt or Se is used as at least a part of a surface of the anode and LaB₆ is used as at least a part of a surface of the cathode.

### Effect of the Invention

According to this invention, it is possible to reduce the power consumption amount of an electrodialyzer.

### BRIEF DESCRIPTION OF THE DRAWINGS

FIG. 1 is a diagram showing a schematic structure of an electrodialyzer.

FIG. 2 is a diagram showing a potential-current curve of an aqueous solution.

FIG. 3 is a diagram of a two-stage electrodialyzer according to a first embodiment of this invention.

FIG. 4 is a diagram showing the operation of a first stage of the electrodialyzer according to the first embodiment of this invention.

FIG. 5 is a diagram showing the operation results of the first stage of the electrodialyzer according to the first embodiment of this invention.

FIG. 6 is a diagram showing the operation of a second stage of the electrodialyzer according to the first embodiment of this invention.

FIG. 7 is a diagram showing the operation results of the second stage of the electrodialyzer according to the first embodiment of this invention.

FIG. 8 is a diagram showing a cathode reaction potential-current curve when Pt is used as an anode and LaB₆ or Pt is used as a cathode in the electrodialyzer of FIG. 1.

FIG. 9 is a diagram for explaining a reduction in power consumption which is realized by a reduction in total voltage using LaB₆ as an electrode material in the electrodialyzer of FIG. 1.

### MODE FOR CARRYING OUT THE INVENTION

Hereinbelow, preferred embodiments of this invention will be described in detail with reference to the drawings.

First, the first embodiment will be described.

The first embodiment is such that electrodialysis is carried out at an interelectrode voltage that does not exceed an electrode reaction threshold voltage.

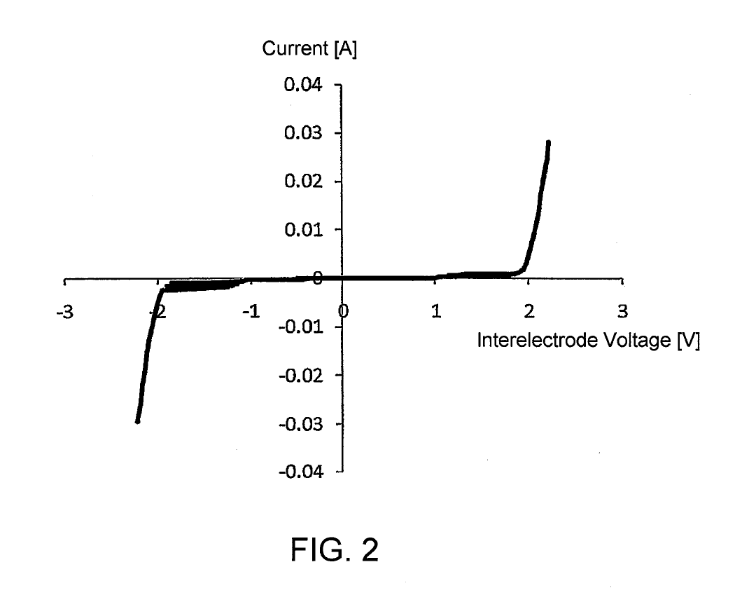

First, referring to FIG. 2, the threshold voltage measurement results will be described.

In an acrylic vessel containing a 3 wt % sodium chloride aqueous solution, an anode and a cathode were disposed so as to face each other at a distance of 3 cm, and a voltage was applied between the electrodes using an external power supply. A platinum plate with a thickness of 0.1 mm was used as a material of each of the anode and the cathode. FIG. 2 shows current amounts plotted versus interelectrode voltages. As shown in FIG. 2, it is seen that when a positive voltage is applied as an electrode voltage difference, current hardly flows up to 2V, while, when a negative voltage is applied as an electrode voltage difference, current hardly flows up to −2V. This means that it is possible to generate a potential gradient in water present between the electrodes with almost no current flowing up to an interelectrode voltage of 4V.

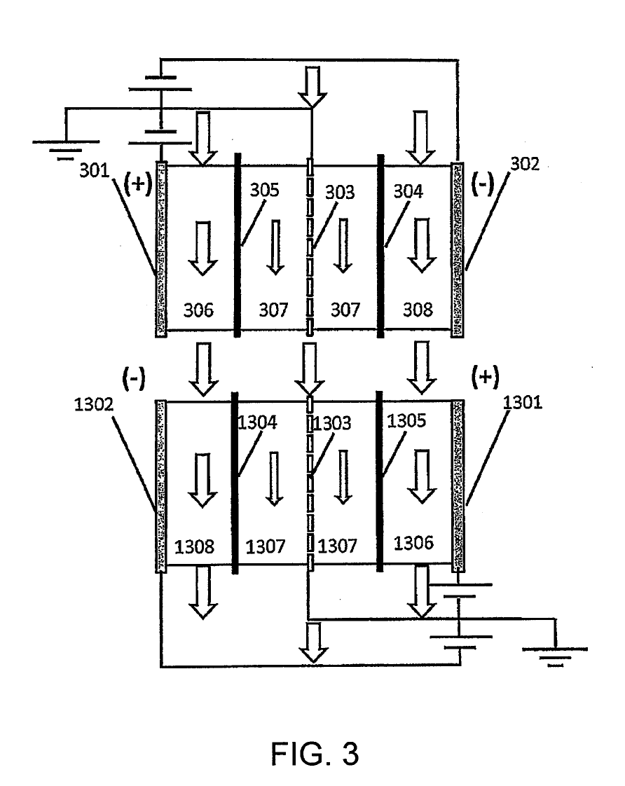

Next, referring to FIG. 3, the basic structure of an electrodialyzer according to the first embodiment of this invention will be described. Although the electrodialyzer is composed of a plurality of stages, a description will be given herein using a two-stage structure as an example. That is, the illustrated electrodialyzer comprises a first-stage electrodialysis portion and a second-stage electrodialysis portion.

The first-stage electrodialysis portion shown in FIG. 3 has a negative ion (anion) exchange membrane 304, a positive ion (cation) exchange membrane 305, and an intermediate electrode 303 between an anode 301 and a cathode 302. The intermediate electrode 303 is an electrode of a structure having a large number of small holes that allow a liquid to pass therethrough in both left and right directions in the figure, and is grounded. Therefore, chambers adjacent to each other through the intermediate electrode 303 can be regarded as the same chamber.

Likewise, the second-stage electrodialysis portion has a negative ion (anion) exchange membrane 1304, a positive ion (cation) exchange membrane 1305, and an intermediate electrode 1303 between an anode 1301 and a cathode 1302. However, the layout of the anode, the cathode, and the ion exchange membranes is reversed in phase with respect to that of the first-stage electrodialysis portion. Specifically, in the first-stage electrodialysis portion, with respect to the center position of a flow direction, indicated by arrows, of an aqueous solution, the anode 301 is disposed on the left side (i.e. one side) in the figure while the cathode 302 is disposed on the right side (i.e. the other side) in the figure, and the cation exchange membrane 305 is disposed on the anode 301 side while the anion exchange membrane 304 is disposed on the cathode 302 side. On the other hand, in the second-stage electrodialysis portion, with respect to the center position of a flow direction of the aqueous solution, the cathode 1302 and the anion exchange membrane 1304 are disposed on the left side (i.e. one side) while the anode 1301 and the cation exchange membrane 1305 are disposed on the right side (the other side).

In the case of an electrodialyzer having a larger number of stages, an anode and a cation exchange membrane, and a cathode and an anion exchange membrane are alternately disposed on the left and right sides with respect to the center position of a flow direction.

The flow of the aqueous solution in the illustrated electrodialyzer is as follows. Specifically, in the case of seawater desalination, in the first stage, seawater is supplied, as feed water to be treated, into a chamber 306 between the anode 301 and the cation exchange membrane 305 and into a chamber 308 between the cathode 302 and the anion exchange membrane 304, while, seawater or fresh water is supplied into a chamber 307 sandwiched between the cation exchange membrane 305 and the anion exchange membrane 304.

The treated water having passed through the chambers 306, 307, and 308 in the first-stage electrodialysis portion flows into and passes through chambers 1306, 1307, and 1308, which are similar to those of the first stage, likewise in the second-stage electrodialysis portion. As described above, however, the layout of the electrodes and the ion exchange membranes is reversed in phase in the second-stage electrodialysis portion.

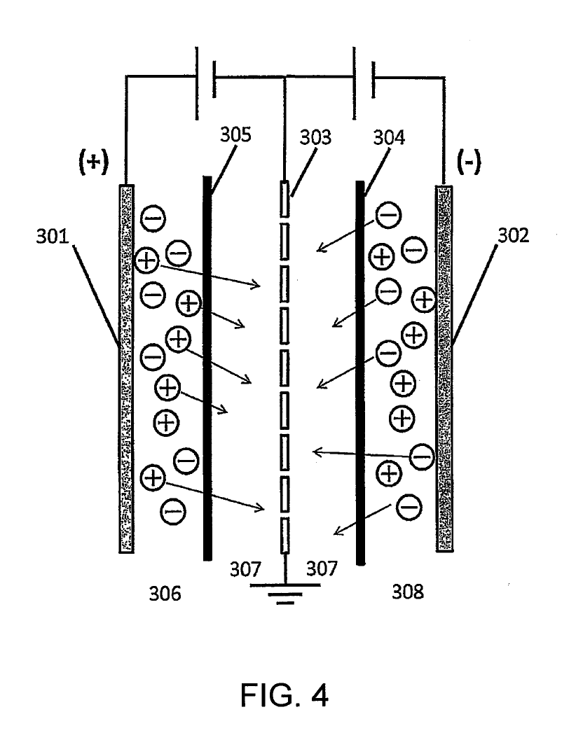

Next, referring to FIGS. 4 to 7, the operation principle of the electrodialyzer according to the first embodiment of this invention will be described.

First-Stage Electrodialysis Portion:

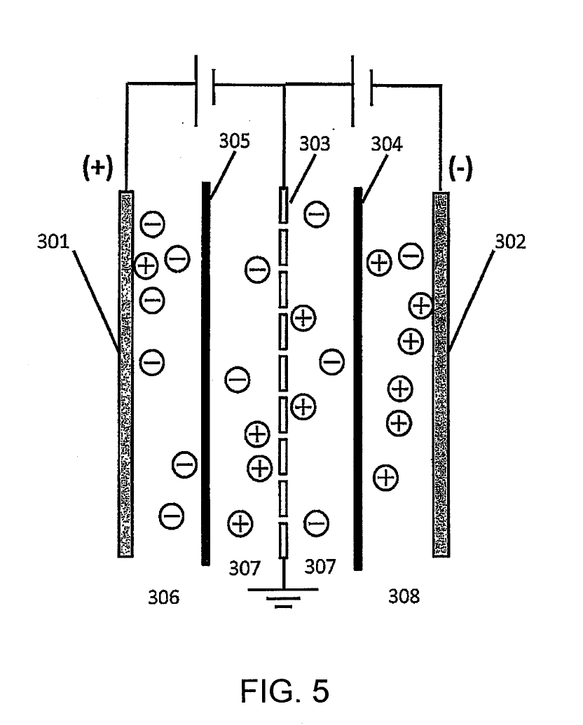

In the first-stage electrodialysis portion, as shown in FIG. 4, cations are reduced in the chamber 306 sandwiched between the anode 301 and the cation exchange membrane 305 while anions are reduced in the chamber 308 sandwiched between the cathode 302 and the anion exchange membrane 304. The results thereof are shown in FIG. 5.

In this manner, water from the chamber 306 where the cations are reduced and water from the chamber 308 where the anions are reduced (conversely speaking, water in which the anions and the cations are respectively concentrated) in the first-stage electrodialysis portion are sent to the second-stage electrodialysis portion.

In the case of seawater, as a voltage to be applied between the anode 301 and the cathode 302 in the first-stage electrodialysis portion, a voltage of +2V or less is applied to the anode 301 with respect to the intermediate electrode 303 while a voltage of −2V or less is applied to the cathode 302 with respect to the intermediate electrode 303. That is, since the voltage not more than the threshold voltage shown in FIG. 2 is applied between the anode 301 and the cathode 302, it is possible to generate a potential gradient in the water with almost no current flowing between both electrodes.

Second-Stage Electrodialysis Portion:

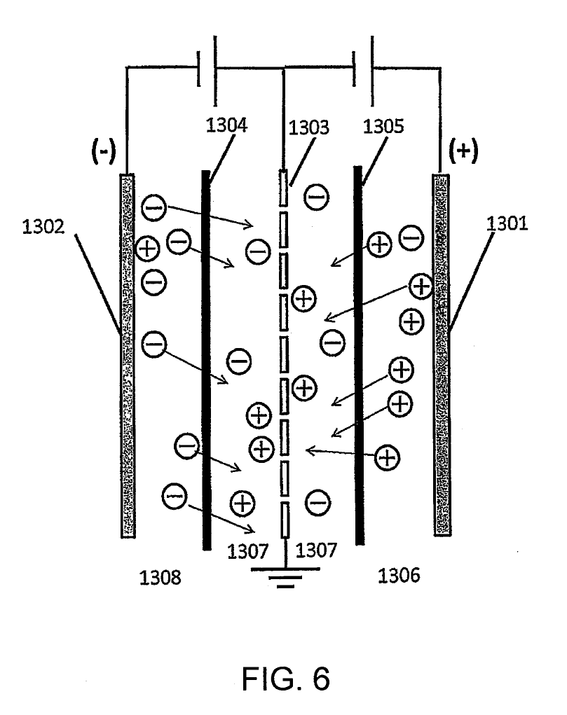

Referring to FIG. 6, as described above, the structure of the second-stage electrodialysis portion is reversed in phase with respect to that of the first-stage electrodialysis portion. The water in the chamber 306 where the cations are reduced in the first-stage electrodialysis portion as shown in FIG. 5 is supplied into the chamber 1308 sandwiched between the cathode 1302 and the anion exchange membrane 1304 in the second-stage electrodialysis portion as shown in FIG. 6, while, the water in the chamber 308 where the anions are reduced in the first-stage electrodialysis portion as shown in FIG. 5 is supplied into the chamber 1306 sandwiched between the anode 1301 and the cation exchange membrane 1305 in the second-stage electrodialysis portion as shown in FIG. 6.

In the second-stage electrodialysis portion, a voltage of +3 to 4V is applied to the anode 1301 with respect to the intermediate electrode 1303 while a voltage of −3 to 4V is applied to the cathode 1302 with respect to the intermediate electrode 1303. That is, the voltage larger in absolute value than that of the first-stage electrodialysis portion is applied to the second-stage electrodialysis portion.

Since the water having passed through the chamber 306 in the first-stage electrodialysis portion and thus containing anions at a concentration unchanged passes through the chamber 1308 sandwiched between the cathode 1302 and the anion exchange membrane 1304 in the second-stage electrodialysis portion, the anions flow into the chamber (concentration chamber) 1307, provided in the center, through the anion exchange membrane 1304 so that the anion concentration in the chamber 1308 is significantly reduced.

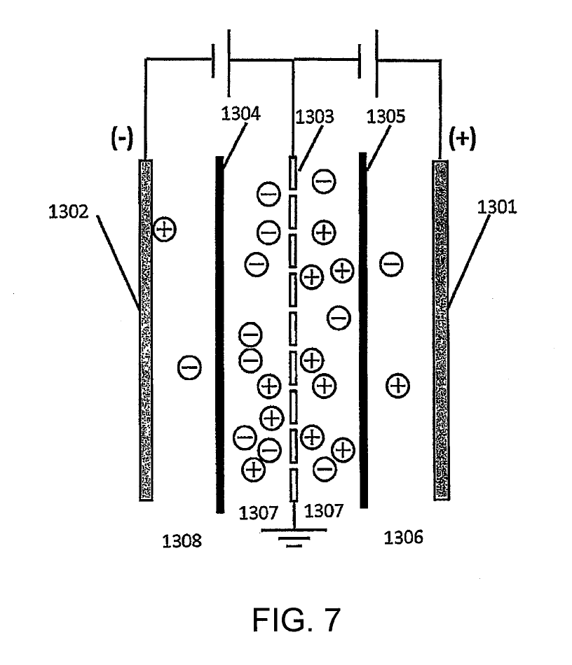

Since the water having passed through the chamber 308 in the first-stage electrodialysis portion and thus containing cations at a concentration unchanged passes through the chamber 1306 sandwiched between the anode 1301 and the cation exchange membrane 1305 in the second-stage electrodialysis portion, the cations flow into the central chamber 1307 through the cation exchange membrane 1305 so that the cation concentration in the chamber 1306 is significantly reduced. The results thereof are shown in FIG. 7.

In this manner, the water to be treated passes through the first stage and the second stage. When the number of stages is increased, by passing the water alternately through the anode side→the cathode side→the anode side→the cathode side, while, passing the water, on the other hand, alternately through the cathode side→the anode side→the cathode side→the anode side in the third and subsequent stages in the same manner as in the first and second stages, the cations and the anions in the water are concentrated into chambers 307, 1307 each provided in a central portion. As the number of stages increases so that the ion concentrations in chambers 306 (1306) and 308 (1308) decrease, it is necessary to increase a voltage to be applied.

However, since the operation is carried out under the condition where almost no current flows, i.e. the interelectrode voltage is set so that the current density becomes 1 mA/cm² or less and preferably 0.1 mA/cm² or less, to thereby remove cations and anions, it is possible to reduce the NaCI concentration with a significantly smaller power consumption amount as compared with the conventional electrodialysis method (current density: several 10 mA/cm²).

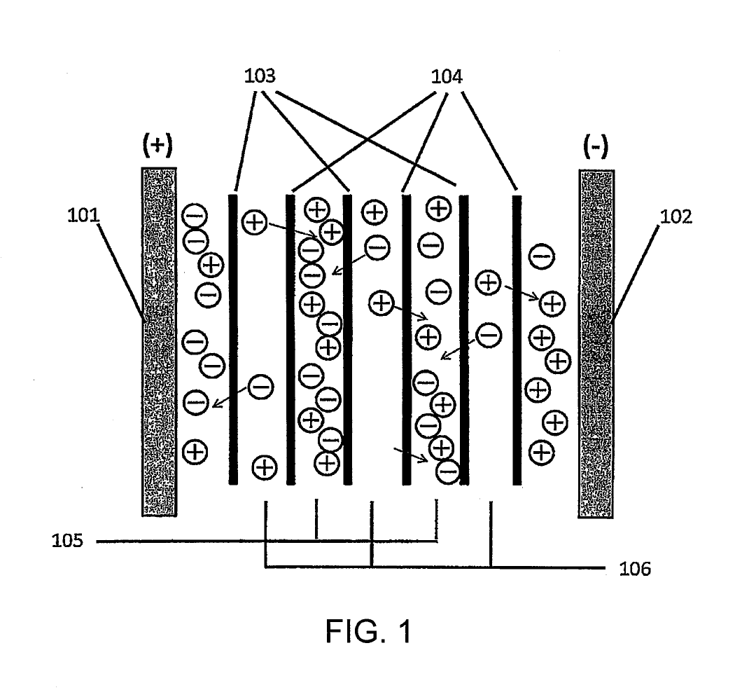

Next, the second embodiment of this invention will be described with reference to FIGS. 1, 8, and 9.

The second embodiment is such that LaB₆ is used as at least a part of a surface of a cathode in an electrodialyzer.

Referring to FIG. 1, one example of an electrodialyzer according to the second embodiment will be described.

The basic structure of the electrodialyzer according to the second embodiment is the same as that shown in FIG. 1, but Pt is used as the anode 101 and LaB₆ or Pt is used as the cathode 102.

As described before, in FIG. 1, the electrodialyzer has the structure in which the plurality of pairs of anion exchange membranes 103 and cation exchange membranes 104 are disposed in parallel and are sandwiched on both sides thereof by the anode 101 and the cathode 102. Hitherto, a Pt-plated Ti electrode or the like is used as a material of each of the electrodes.

The operation of the electrodialyzer intended for seawater is as described above, but will be briefly described again. Cations and anions are always present in an aqueous solution containing salt.

(1) When seawater is supplied into the vessel provided with the anode 101 and the cathode 102 and a voltage is applied between the two electrodes, ions are attracted to the opposite-polarity electrodes due to electrophoresis. Herein, if the cation exchange membrane 104 is present between the two electrodes, the migrating anions cannot pass through this cation exchange membrane 104. On the other hand, the cations can pass through this cation exchange membrane 104 to move to the electrode side. If the anion exchange membrane 103 is present between the two electrodes, this shall be reversed.

(2) Since, as described above, the cation exchange membranes and the anion exchange membranes 103 are alternately inserted between the anode 101 and the cathode 102 in the electrodialyzer, two water flow paths or compartments are formed. Then, when salt water as a liquid to be treated is supplied and a current is caused to flow between the two electrodes, the above-mentioned ion movements alternately occur so that there can be formed the flow path in which both anions and cations are concentrated and the flow path in which both anions and cations are removed, i.e. diluted. As a consequence, a salt-concentrated liquid (Condense) and a desalinated liquid (Dilute) are obtained at outlets of the two flow paths.

Only several ion exchange membranes are shown in FIG. 1, but in an actual electrodialyzer, for example, 300 pairs of anion exchange membranes 103 and cation exchange membranes 104 are disposed in parallel for efficiently using the current. Hitherto, when desalination is carried out to reduce the seawater salt concentration from 3.5% to 2.7% in an electrodialysis cell having a structure in which the anion exchange membranes 103 and the cation exchange membranes 104 are sandwiched on both sides thereof by Pt-plated Ti electrodes, a voltage of about 250V is required. A rough breakdown of the voltage is a 300-pair intermembrane voltage of 240V and a voltage of 10V at the electrode portions.

The second embodiment pays attention to LaB₆ as an electrode material in such an electrodialyzer, thereby realizing a reduction in power consumption.

In terms of features such as high melting point, low work function, and high electron emission rate, LaB₆ is widely used as a thermion emission material for electron microscopes and so on. The low work function corresponds to high electron emission capability. Work functions of several materials are shown below as examples, wherein the superiority of LaB₆ is apparent.

| Material | Work Function (eV) |
|---|---|
| Se | 5.9 |
| Pt | 5.7 |
| Pd | 5.1 |
| Ti | 4.3 |
| LaB₆ | 2.4 |

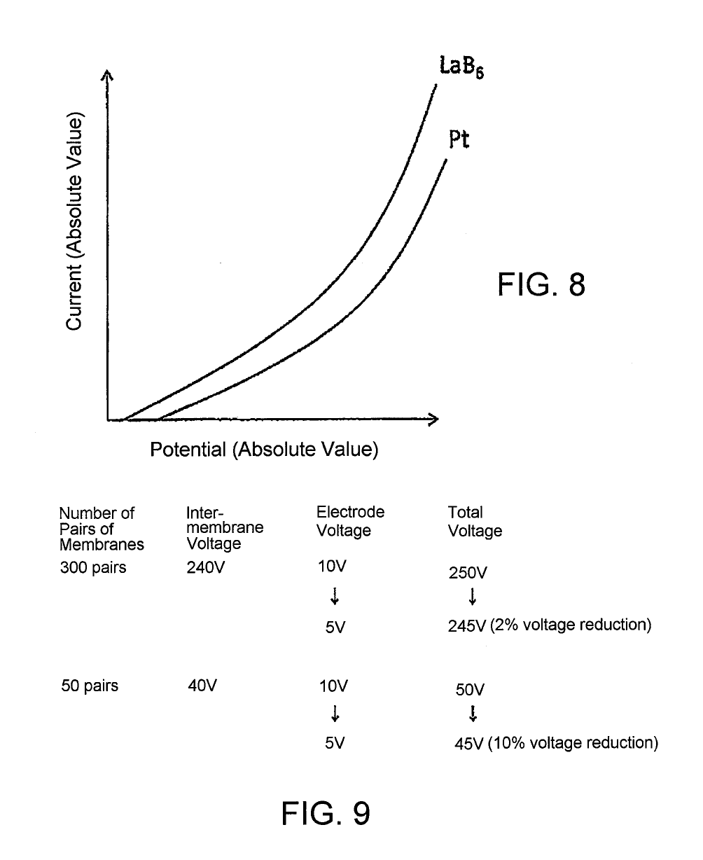

An electrode reaction in an electrodialyzer is an electron exchange reaction between an aqueous solution and an electrode and it is expected that as the electron donating ability increases, a cathode reaction that donates an electron to a molecule or an ion in the solution is promoted. FIG. 8 shows a cathode reaction potential-current curve when Pt is used as the anode 101 while LaB₆ is used as the cathode 102.

As is clear from FIG. 8, when a constant current is caused to flow using LaB₆ as the cathode 102, the electrode reaction proceeds at a lower voltage due to its high electron emission characteristics as compared with the case where Pt is used as the cathode 102. As a consequence, using LaB₆ as the electrode of the electrodialyzer, it is possible to reduce the power consumption amount in the electrode reaction.

In order to maximize the effect of the LaB₆ electrode, the number of ion exchange membranes in the electrodialyzer is preferably as small as possible. As shown in FIG. 9, in the above-mentioned electrodialysis cell in which the 300 pairs of anion exchange membranes 103 and cation exchange membranes 104 are disposed in parallel, a voltage of 240V between the 300 pairs of membranes and a voltage of 10V at the electrode portions are required for carrying out desalination to reduce the seawater salt concentration from 3.5% to 2.7%. In this case, even if the voltage at the electrode portions can be reduced from 10V to 5V using LaB₆ as the cathode 102, since the intermembrane voltage of the 300 pairs of ion exchange membranes is 240V, a voltage reduction is only 2% (=5/250) relative to the total voltage being the sum of the electrode portion voltage and the intermembrane voltage and thus the influence upon a reduction in the power consumption of the entire electrodialyzer is not great.

Accordingly, in order to maximize the effect of using LaB₆ as the cathode 102, it is preferable to reduce the number of ion exchange membranes in the electrodialyzer. For example, if the number of pairs of ion exchange membranes is reduced from 300 pairs to 50 pairs, the intermembrane voltage becomes 40V while the electrode portion voltage can be reduced from 10V to 5V and, therefore, the reduction effect relative to a total voltage of 50V due to the use of the electrode of LaB₆ is improved from 2% described above to 10% (=5/50) so that a large reduction in power consumption is enabled.

The cathode 102 may be made of LaB₆ alone as described above, but may alternatively be such that at least a part of a surface of a material (e.g. W, Mg, Ti, or the like) different from LaB₆ is coated with a LaB₆ film. On the other hand, as the anode 101, Se may be used instead of Pt. The anode 101 may be made of Pt or Se alone and may alternatively be such that at least a part of an electrode surface of a different material is coated with a Pt or Se film.

### INDUSTRIAL APPLICABILITY

This invention is applicable not only to a seawater desalination apparatus, but also to a salt or bittern manufacturing apparatus.

### Description of Symbols

301, 1301 anode
302, 1302 cathode
303, 1303 intermediate electrode

1. An electrodialyzer comprising a pair of electrodes and at least one or more ion exchange membranes which are disposed between the pair of electrodes, wherein a voltage substantially not causing current to flow is applied between the electrodes.

2. An electrodialyzer comprising a pair of electrodes and a pair of a cation exchange membrane and an anion exchange membrane which are disposed between the pair of electrodes, wherein a voltage substantially not causing current to flow is applied between the electrodes.

3. The electrodialyzer according to claim 2, wherein an electrode having a hole that allows water to pass therethrough is inserted between the pair of ion exchange membranes.

4. An electrodialyzer comprising a pair of electrodes and at least one or more ion exchange membranes which are disposed between the pair of electrodes, wherein a voltage to be applied between the electrodes is set so that a current density of a current that flows between the electrodes becomes 1 mA/cm² or less.

5. The electrodialyzer according to claim 1, wherein an interelectrode voltage is set so that a current density at the electrodes becomes 0.1 mA/cm² or less.

6. A seawater desalination apparatus using the electrodialyzer according to claim 1.

7. An electrodialyzer comprising a first-stage electrodialysis portion comprising an anode and a cathode respectively disposed on one side and the other side with respect to a center position of a flow direction of a liquid to be treated, and a cation exchange membrane and an anion exchange membrane respectively disposed on said one side and said other side so as to be respectively adjacent to the anode and the cathode, and a second-stage electrodialysis portion comprising a cathode and an anode respectively disposed on said one side and said other side, reversely to the first-stage electrodialysis portion, with respect to a center position of a flow direction of the liquid to be treated from the first-stage electrodialysis portion, and an anion exchange membrane and a cation exchange membrane respectively disposed on said one side and said other side so as to be respectively adjacent to the cathode and the anode.

8. The electrodialyzer according to claim 7, wherein a voltage substantially not causing current to flow is applied between the anode and the cathode in the first-stage electrodialysis portion.

9. The electrodialyzer according to claim 8, wherein a voltage causing a current density of a current, that flows between the electrodes, to be 1 mA/cm² or less is applied between the anode and the cathode in the second-stage electrodialysis portion.

10. The electrodialyzer according to claim 7, wherein an intermediate electrode grounded and having a hole that allows water to pass therethrough is provided at a center position of each of the first-stage and second-stage electrodialysis portions.

11. The electrodialyzer according to claim 7, wherein a third-stage electrodialysis portion is provided as a stage subsequent to the second-stage electrodialysis portion, wherein, in the third-stage electrodialysis portion, an anode and a cation exchange membrane are provided on said one side as in the first-stage electrodialysis portion and a cathode and an anion exchange membrane are provided on said other side as in the first-stage electrodialysis portion.

12. The electrodialyzer according to claim 11, wherein a fourth-stage electrodialysis portion is provided as a stage subsequent to the third-stage electrodialysis portion, wherein, in the fourth-stage electrodialysis portion, an anode and a cation exchange membrane are provided on said other side as in the second-stage electrodialysis portion and a cathode and an anion exchange membrane are provided on said one side as in the second-stage electrodialysis portion.

13. An electrodialyzer having a structure in which a plurality of pairs of anion exchange membranes and cation exchange membranes are disposed in parallel and are sandwiched on both sides thereof by an anode and a cathode, the electrodialyzer wherein Pt or Se is used as at least a part of a surface of the anode and LaB₆ is used as at least a part of a surface of the cathode.

14. The electrodialyzer according to claim 13, wherein the cathode is made of LaB₆ alone or is such that a surface of a material different from LaB₆ is coated with LaB₆.

15. The electrodialyzer according to claim 13, reducing the number of pairs of the ion exchange membranes to reduce an intermembrane voltage of the pairs of the ion exchange membranes, thereby reducing a total voltage being the sum of the intermembrane voltage and an electrode portion voltage so as to realize a reduction in power consumption.
